(19) United States
(12) Patent Application Publication
(10) Pub. No.: US 2009/0001619 A1
(43) Pub. Date: Jan. 1, 2009

(54) OPTICAL GLASS FORMING MOLD AND METHOD FOR PRESS-FORMING OPTICAL GLASS USING SUCH OPTICAL GLASS FORMING MOLD

(75) Inventor: Sunao MIYAZAKI, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 12/199,840

(22) Filed: Aug. 28, 2008

Related U.S. Application Data
(63) Continuation of application No. PCT/JP07/54359, filed on Mar. 6, 2007.

(30) Foreign Application Priority Data
Mar. 7, 2006 (JP) 2006-061193

(51) Int. Cl. B29D 11/00

(52) U.S. Cl. 264/1.1; 65/374.12; 249/116; 427/135

(57) ABSTRACT

The invention provides: a mold for molding optical glass, the mold comprising: a mold base; and a protective film comprising one or two or more layers formed on the mold base, the outermost layer of the protective film containing one or more elements selected from the group consisting of Al, Ga, In, Tl, Ge, Sn, Pb, As, Sb, Bi, S, Se, and Te; a process for producing the mold; and a process for press-molding with the mold.

### TECHNICAL FIELD

The present invention relates to a mold for optical glasses. More particularly, the invention relates to a mold for optical glasses which is for use in high-precision press molding which gives a press-molded article which need not be subjected to a polishing step or the like after the press-molding.

### BACKGROUND ART

The technique of precision press molding which press-molds an optical glass element, e.g., a glass lens, capable of being used as it is without undergoing molded-surface polishing or the like is receiving attention in recent years. The molds for use in the technique of precision press molding are required to have a high level of shape accuracy and surface smoothness. In addition, the molds are required to have the property of not reacting with or adhering to the optical glass even at high temperatures of about 400-800° C., i.e., excellent releasability, and to further have excellent durability in mass-production, such as abrasion resistance, heat resistance, and thermal shock resistance.

Such a mold for optical glasses which comprises a mold base and a surface layer comprising an alloy of a noble metal, e.g., platinum, formed on the mold base is proposed in patent document 1 or patent document 2. However, the molds described in these documents are apt to adhere to optical glasses and are insufficient in releasability. There have hence been problems, for example, that the optical glass element, e.g., a lens, tenaciously adheres to the mold and the product cannot be taken out or cracks when taken out.

Furthermore, a mold coated with a thin film of a noble-metal alloy containing 0.01-10% by mass Zr, Ti, or Hf element is proposed in patent document 3 as a mold satisfactory in abrasion resistance and wearing resistance. However, the mold proposed in this document still has a problem concerning releasability because such an element, e.g., Ti, has high reactivity with optical glasses.

Patent Document 1: JP-A-10-36128

Patent Document 2: JP-A-2001-322827

Patent Document 3: JP-B-1-40780

### DISCLOSURE OF THE INVENTION

### Problems to be Resolved by the Invention

An object of the invention is to provide a mold for optical glasses which is excellent in releasability and durability and is suitable for precision press molding.

### Means of Solving the Problems

The present inventors made intensive investigations on the problems described above. As a result, they have found that the object can be accomplished with the mold for optical glasses shown below, the process for producing a mold for optical glasses shown below, and the method for press-molding an optical glass shown below. The invention has been thus achieved.

(1) A mold for molding optical glass, the mold comprising: a mold base; and a protective film comprising one or two or more layers formed on the mold base, the outermost layer of the protective film containing one or more elements selected from the group consisting of Al, Ga, In, Tl, Ge, Sn, Pb, As, Sb, Bi, S, Se, and Te.

(2) The mold for optical glass according to item (1), wherein the protective film comprises two or more layers, and a layer adjoining the outermost layer comprises noble-metal element.

(3) The mold for optical glass according to item (1), wherein the outermost layer comprises noble-metal element.

(4) The mold for optical glass according to item (3), wherein the outermost layer comprises: 1-70 atom % of one or more elements selected from the group consisting of Al, Ga, In, Tl, Ge, Sn, Pb, As, Sb, Bi, S, Se, and Te; and 30-99 atom % of noble-metal element.

(5) The mold for optical glass according to item (2), (3), or (4), wherein the noble-metal element containing one or more metallic elements selected from the group consisting of Ir, Re, Os, Pd, Pt, Au, Rh, Ru, Ta, and W.

(6) The mold for optical glass according to any one of items (1) to (5), wherein the mold base comprises a superhard alloy material or a silicon carbide material.

(7) A process for producing a mold for molding optical glass, the mold comprising: a mold base; and a protective film comprising one or two or more layers formed on the mold base, the process comprising: preliminarily molding a glass containing one or more elements selected from the group consisting of Al, Ga, In, Ti, Ge, Sn, Pb, As, Sb, Bi, S, Se, and Te to form a layer containing one or more elements selected from the group consisting of Al, Ga, In, Tl, Ge, Sn, Pb, As, Sb, Bi, S, Se, and Te as the outermost layer of the protective film.

(8) A method for press-molding an optical glass with a pressing mold comprising an upper die and a lower die, at least either of the upper die and the lower die being the mold for optical glass according to any one of items (1) to (6).

### ADVANTAGEOUS EFFECTS OF THE INVENTION

The mold for optical glasses of the invention (hereinafter referred to as mold of the invention) comprises a mold base and a protective film comprising one or two or more layers formed on the mold base, and the outermost layer of the protective film contains one or more elements selected from the group consisting of Al, Ga, In, Ti, Ge, Sn, Pb, As, Sb, Bi, S, Se, and Te. The mold of the invention has low reactivity with optical glasses and hence has greatly improved releasability from optical glasses. Furthermore, because the outermost layer of the protective film contains the elements, the properties required of molds, such as abrasion resistance and wearing resistance, are improved and the life can be prolonged. Moreover, since the mold base material employed is a superhard alloy material or a silicon carbide material, the mold is excellent also in mechanical properties and precision in shape, etc. Thus, a mold suitable for precision press molding can be provided.

### BRIEF DESCRIPTION OF THE DRAWINGS

FIG. 1 are diagrammatic sectional views of lower dies of a mold of the invention.

FIG. 2 is a diagrammatic sectional view of the press-molding apparatus used in the Examples.

### DESCRIPTION OF THE REFERENCE NUMERALS AND SIGNS

1: mold base
2: protective film
3: outermost layer
10: lower die
24: chamber
25: upper pressing shaft
26: lower pressing shaft
27, 28: heater block
29: upper die
30: lower die
31: optical glass as work
32: hydraulic cylinder

### BEST MODE FOR CARRYING OUT THE INVENTION

The mold of the invention is a mold which comprises a mold base and a protective film comprising one or two or more layers formed on the mold base and is for use in molding an optical glass element, e.g., a lens. This mold is characterized in that the outermost layer of the protective film contains one or more elements selected from the group of elements consisting of Al, Ga, In, Tl, Ge, Sn, Pb, As, Sb, Bi, S, Se, and Te (hereinafter abbreviated to the group of elements including Al).

The term outermost layer of the protective film means the layer which includes a surface coming into contact with an optical glass during molding. When the protective film on the mold base consists of one layer, this layer is the outermost layer. When the protective film on the mold base is composed of two layers, the second layer as counted from the mold base side is the outermost layer. Likewise, when the protective film is composed of n layers, the n-th layer as counted from the mold base side is the outermost layer. In the case where the protective film is composed of two or more layers, the layer in contact with the mold base, i.e., the first layer as counted from the mold base, may be a layer for enhancing adhesion between the mold base and the protective layer. Preferred examples of such a layer include a layer comprising Ti.

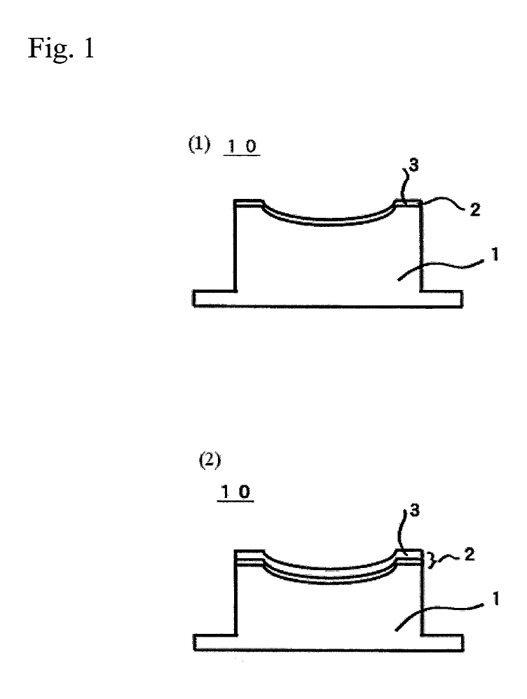

Embodiments of the mold of the invention are shown in FIG. 1. FIG. 1 are vertical sectional views of lower dies of a pressing mold. In FIG. 1, (1) shows the case where the protective film on the mold base consists of one layer and (2) shows the case where the protective film on the mold base is composed of two layers. In the figure, numeral 1 denotes a mold base, 2 a protective film, and 3 the outermost layer of the protective film. In the case (1) in FIG. 1, the protective film 2 serves also as the outermost layer 3 of the protective film.

The group of elements including Al have low reactivity with optical glasses. Because such elements are contained in the outermost layer, the optical glass element does not adhere to the mold and can be easily released therefrom. Preferred of the group of elements including Al are Sn, Pb, As, Sb, Bi, and Te elements. This is because addition of any of these elements to the outermost layer brings about satisfactory product releasability from the mold. Especially preferred are Bi and Te elements.

Furthermore, because the group of elements including Al are contained in the outermost layer, the outermost layer has an increased hardness to greatly improve the abrasion resistance and wearing resistance of the mold. From the standpoint of mechanical properties including hardness, Al, Ga, In, Tl, Ge, and the like are preferred of the group of elements including Al. When the outermost layer is one which contains noble-metal element besides one or more elements selected from the group of elements including Al, this outermost layer is preferred because it improves mechanical properties. When the outermost layer consists substantially of noble-metal element and one or more elements selected from the group of elements including Al, this outermost layer is more preferred for the same reason. In this case, it is thought that the noble-metal element in the outermost layer is present as finer particles due to the presence of the one or more elements and, as a result, the outermost layer of the protective film has a finer structure to thereby improve mechanical properties. The term “substantially” herein means that the sum of the one noble-metal element and the elements including Al is 99 atom % or more.

In the case where the outermost layer is composed substantially of the noble-metal element and one or more elements selected from the group of elements including Al, it is preferred that the one or more elements should account for 1-70 atom % and the noble-metal element should account for 30-99 atom % of the outermost layer. In case where the content of the elements is lower than 1 atom %, there is a possibility that the effect of lowering adhesion to optical glasses and the effect of heightening the hardness of the protective film might not be sufficiently obtained. The lower limit of the content of the elements is preferably 5 atom %, more preferably 10 atom %.

On the other hand, in case where the content of the elements exceeds 70 atom %, not only the outermost layer of the protective film comes to have a coarse structure and the press-molding surface cannot have mirror surface characteristics, but also the film is apt to peel off. The upper limit of the content of the elements is preferably 50 atom %, more preferably 40 atom %.

Likewise, in case where the content of the noble-metal element exceeds 99 atom %, there is a possibility that the effect of lowering adhesion to optical glasses and the effect of heightening the hardness of the protective film might not be sufficiently obtained. The upper limit of the content of the noble-metal element is preferably 95 atom %, more preferably 90 atom %. On the other hand, in case where the content of the noble-metal element is lower than 30 atom %, not only the outermost layer of the protective film comes to have a coarse structure and the press-molding surface cannot have mirror surface characteristics, but also the film is apt to peel off. The lower limit of the content of the noble-metal element is preferably 50 atom %, more preferably 60 atom %. When the outermost layer is a layer containing one or more elements selected from the group of elements including Al and the layer adjoining this outermost layer is a layer comprising noble-metal element, then the same effects as in the case where the outermost layer is composed substantially of the noble-metal element and one or more elements selected from the group of metals including Al are obtained.

The noble-metal element in the mold of the invention is not particularly limited as long as it is a metallic element belonging to Group 5 to Group 11 of the periodic table. The noble-metal element preferably is one or more metallic elements selected from the group of metallic elements consisting of Ir, Re, Os, Pd, Pt, Au, Rh, Ru, Ta, and W (hereinafter abbreviated to the group of metallic elements including Ir), because desired properties are balanced. When the protective film contains one or more of Ir, Re, Pt, Rh, and Ru among the group of metallic elements including Ir, this protective film is preferred from the standpoint of the abrasion resistance, wearing resistance, and durability of the mold. More preferably, Ir is contained.

Methods for forming the protective film in the mold of the invention are not particularly limited. Preferred methods include the sputtering method using a sputtering target, vacuum deposition method, ion implantation method, and the like.

A mold comprising a mold base and deposited thereon a protective film comprising a noble-metal element may be used to press-mold a glass containing elements in the group of elements including Al, e.g., Te or Bi, whereby a layer comprising a deposition of the Te or Bi or a layer containing the Te or Bi is formed on the layer of the noble-metal element. Namely, a layer comprising a deposit of elements in the group of elements including Al or a layer containing elements in the group of elements including Al may be thus formed, as the outermost layer of the protective film, on the layer of the noble-metal element, etc.

The mold base in the mold of the invention preferably is made of a superhard alloy material comprising WC as the main compound or of a silicon carbide material comprising SiC as the main component. This selection is preferred from the standpoints of mechanical properties, heat resistance, mirror surface characteristics, suitability for production, etc. The term “comprising . . . as the main component” herein means that the content of this ingredient is 80% by mass or higher.

### EXAMPLES

Embodiments of the invention will be explained below by reference to Examples. However, the invention should not be construed as being limited to the following Examples.

Examples of the invention are explained below.

The optical glasses used for tests were the following two glasses: borosilicate glass SK5 (refractive index n_{d}=1.589; Abbe number ν_{d}=61.2; transition temperature T_{g}=527° C.; yield point=567° C.; composition in terms of % by mass (hereinafter abbreviated simply to %), 44% of SiO₂, 11% of B₂O₃, 4% of Al₂O₃, 7% of Li₂O, 16% of SrO, 7% of CaO, 1% of BaO, 4% of ZnO, and 4% of ZrO₂) and lanthanum-containing glass LaSF03 (refractive index n_{d}=1.806; Abbe number ν_{d}=40.9; transition temperature T_{g}=610° C.; yield point=637° C.; composition, 6% of SiO₂, 21% of B₂O₃, 4% of WO₃, 3% of BaO, 1% of Al₂O₃, 12% of ZnO, 4% of ZrO₂, 39% of La₂O₃, and 10% of Nb₂O₅).

### [Experiment A]

The molds to be evaluated were produced by the following method. Cylinders having a diameter of 18 mm and a height of 50 mm made of a superhard alloy were processed to obtain a pair of optical-glass-lens pressing molds consisting of an upper die and a lower die each having a concave pressing surface having a radius of curvature of 16 mm. The pressing surfaces of the upper die and lower die were mirror-polished with abrasive diamond grains having a grain diameter of 0.1 μm. Thereafter, a titanium layer having a thickness of 50 nm was deposited as the first layer of a protective film on the mirror surfaces by the sputtering method. Subsequently, an outermost layer having a thickness of 250 nm and having a composition shown in Table 1 (the numeral affixed to each element symbol is in atom %) was deposited to produce molds to be evaluated. Incidentally, the composition of the outermost layer was regulated by placing a desired number of chips of each metal on an iridium target so as to result in the desired composition.

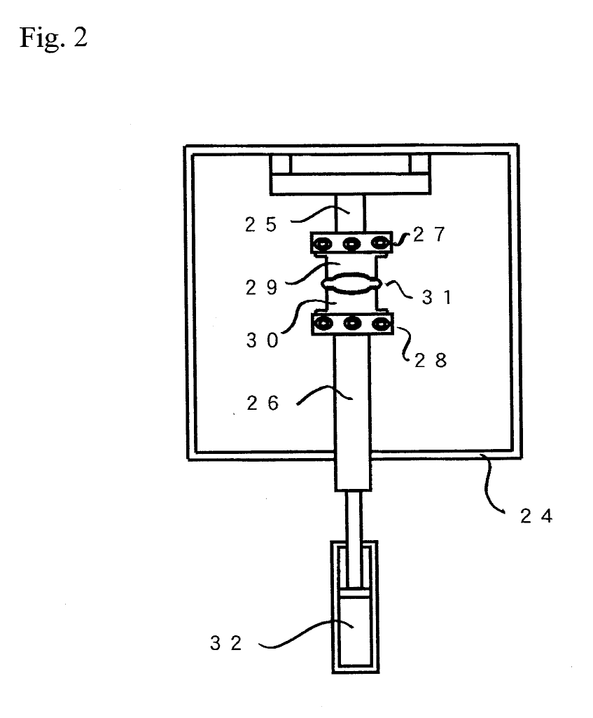

Subsequently, those molds were used to mold an optical glass element (lens) to evaluate releasability, coating film peeling, etc. A diagrammatic sectional view of the press-molding apparatus used for the test is shown in FIG. 2. In the figure, numeral 24 denotes a chamber, 25 an upper shaft, 26 a lower shaft, 27 and 28 a block having a built-in heater (heater block), 29 an upper die, 30 a lower die, 31 an optical glass as a work, and 32 a hydraulic cylinder. In FIG. 2, the work 31 shown is in the form of a lens obtained by molding. However, the materials used, i.e., the materials to be molded, were polished ball preforms (ball lenses) having a diameter of 8 mm.

The procedure of press molding is as follows. The chamber 24 was evacuated with a vacuum pump not shown in the figure. Thereafter, N₂ gas was introduced to make the inside of the chamber 24 be an N₂ atmosphere. Subsequently, the upper die 29 and lower die 30 were heated with the heater blocks 27 and 28. At the time when these dies had been heated to a temperature corresponding to 10⁻⁹ dPa·s in terms of the viscosity of the glass to be molded (596° C. for SK5 or 660° C. for LaSFO3), the lower shaft 26 was pulled down with the hydraulic cylinder 32 and a work (ball lens) was set on the lower die 30 with an auto-hand not shown in the figure.

The work was held at that die temperature for 3 minutes. Subsequently, the lower shaft 26 was elevated with the hydraulic cylinder 32 to press the ball lens with the upper die 29 and the lower die 30 at a force of 3,000 N for 1 minute. Thereafter, the upper die and lower die were cooled at a rate of 100° C./min. At the time when the temperature of the upper die and lower die had reached a desired temperature (515° C. for SK5 or 600° C. for LaSFO3), the lower die 30 was lowered and the molded article 31 on the lower die 30 was taken out by the auto-hand not shown in the figure. Subsequently, the molded article 31 was taken out of the chamber 24 through a replacement apparatus not shown in the figure. The procedure described above was repeated as one cycle to conduct 1,000 shots of press molding.

In the molded articles 31 molded with the molds of Example 1 to Example 26, no molding failures such as, e.g., cracks were observed and no change was observed in the molds.

Example 27 and Example 28 are Examples in which the outermost layers of the upper die 29 and lower die 30 do not contain the group of elements including Al. Among the molded articles molded with these molds, many ones had cracks.

Example 29 is an Example in which the amount of the group of elements including Al added to the outermost layers was reduced to below 1 atom %. Reduced releasability was observed in molding with this mold, and the molded articles obtained sporadically had cracks. However, the rate of occurrence of cracking in these molded articles and the degree of cracking therein were lower than in Example 27 and Example 28. Consequently, the mold of Example 29 was judged fair.

Example 30 and Example 31 are Examples in which the amount of the group of elements including Al added to the outermost layers was increased to beyond 70 atom %. Although no decrease in releasability was observed in molding with these molds, the mold surfaces had slightly reduced mirror surface characteristics. Although a decrease in mirror surface characteristics was observed, the molded articles obtained were not on such a level that they could not be used as optical elements. The molds of Examples 30 and 31 were hence judged fair.

Incidentally, there was no difference in releasability, mirror surface characteristics, or rate of occurrence of cracking between the glass materials.

### [Experiment B]

A titanium layer having a thickness of 50 nm was deposited as the first layer of a protective film on mold bases in the same manner as in Experiment A. Thereafter, a noble-metal alloy film shown in Table 2 was deposited in a thickness of 250 nm as a second layer by the sputtering method. A film of an alloy of Bi and/or Te with noble-metal elements (composite film) was deposited in a thickness of 50 nm as a third layer, i.e., as an outermost layer, by sputtering. A molding test was conducted in the same manner as in Experiment A, except that the molds thus produced were used. The results of the molding test are shown in Table 2 as Example 32 to Example 44 together with the film compositions.

### [Experiment C]

A noble-metal alloy film was deposited in a thickness of 250 nm as a second layer by the sputtering method in the same manner as in Experiment B. An outermost layer was formed by preliminarily molding an optical glass containing Bi and Te elements as components. Specifically, an optical glass containing Bi and Te elements in amounts shown in Table 3 was formed into polished ball preforms having a diameter of 8 mm, and these preforms were preliminarily molded in five shots under the same pressing conditions as in Experiment A. Thereafter, outermost surface parts of each mold were analyzed by ESCA (X-ray photoelectron spectroscopy). As a result, it was ascertained that Bi and Te elements were contained in a total amount of 5-80 atom % although the content thereof was uneven from site to site. The molds which had undergone the preliminary five-shot molding were used as they were to conduct the same molding test as in Experiment A. The results thereof are shown in Table 3 as Example 45 to Example 50. Satisfactory molding test results were obtained in each Example.

### [Experiment D]

A molding test was conducted in the same manner as in Experiment C, except that in place of conducting five-shot preliminary molding using a polished ball preform having a diameter of 8 mm under the same pressing conditions as in Experiment A, a both-side-polished cylinder having a diameter of 18 mm and a thickness of 2 mm was used to conduct preliminary molding three times in which the cylinder was sandwiched between the upper die and lower die and subjected only to the temperature cycling shown in Experiment A while applying substantially no pressure. Each mold gave satisfactory molding test results. The outermost surfaces of the molds were analyzed by ESCA in the same manner as in Experiment C. As a result, it was found that the total content of Bi and Te elements in a flat part of each mold was 5-80 atom % and the total content of Bi and Te elements in a curved part of the mold was 0-5 atom %. The reason why the curved part had such a low Bi and Te element content may be that the glass had not been in contact with the part during the thermal cycling and only a slight amount of volatile ingredients had deposited thereon.

It can be seen from those results that satisfactory results are obtained with molds in which at least the flat parts thereof have the film according to the mold of the invention. The reasons for this are that in the case of molding a lens having a flat part in a peripheral part thereof, the flat part of the lens is apt to crack because it is restrained by the mold and that this cracking is inhibited by the film according to the invention.

TABLE 1

| | Film composition of | |
|---|---|---|
| No. | outermost layer | Results of molding test |
| Example 1 | Ir66-Re33-Te1 | good |
| Example 2 | Ir60-Re10-Te30 | good |
| Example 3 | Ir20-Re10-Te70 | good |
| Example 4 | Ir66-Re33-Bi1 | good |
| Example 5 | Ir60-Re10-Bi30 | good |
| Example 6 | Ir20-Re10-Bi70 | good |
| Example 7 | Ir95-Te5 | good |
| Example 8 | Ir50-Te50 | good |
| Example 9 | Ir90-Bi10 | good |
| Example 10 | Ir60-Bi10-Te30 | good |
| Example 11 | Ir50-Ru10-Te40 | good |
| Example 12 | Ir60-Pt30-Te10 | good |
| Example 13 | Ir30-Rh10-Te60 | good |
| Example 14 | Ir66-Re33-Sn1 | good |
| Example 15 | Ir60-Re10-Pb30 | good |
| Example 16 | Ir20-Re10-As70 | good |
| Example 17 | Ir66-Re33-Sb1 | good |
| Example 18 | Ir60-Re10-S30 | good |
| Example 19 | Ir20-Re10-Se70 | good |
| Example 20 | Ir95-Al5 | good |
| Example 21 | Ir95-Ga5 | good |
| Example 22 | Ir90-In10 | good |
| Example 23 | Ir95-Tl15 | good |
| Example 24 | Ir50-Ru30-Ge20 | good |
| Example 25 | Ir60-Pt30-As10 | good |
| Example 26 | Ir30-Rh10-Sb60 | good |
| Example 27 | Ir66-Re34 | cracking occurred |
| Example 28 | Ir85-Re15 | cracking occurred |
| Example 29 | Ir66-Re33.5-Te0.5 | fair |
| Example 30 | Ir20-Re5-Te75 | fair |
| Example 31 | Ir10-Re5-Te85 | fair |

TABLE 2

| | | Film composition | Results of |
|---|---|---|---|
| | Film composition | of outermost layer | molding |
| No. | of second layer | (third layer) | test |
| Example 32 | Ir66-Re34 | Ir66-Re33-Te1 | good |
| Example 33 | Ir85-Re15 | Ir60-Re10-Te30 | good |
| Example 34 | Ir66-Re34 | Ir20-Re10-Te70 | good |
| Example 35 | Ir85-Re15 | Ir66-Re33-Bi1 | good |
| Example 36 | Ir66-Re34 | Ir60-Re10-Bi30 | good |
| Example 37 | Ir85-Re15 | Ir20-Re10-Bi70 | good |
| Example 38 | Ir66-Re34 | Ir95-Te5 | good |
| Example 39 | Ir85-Re15 | Ir50-Te50 | good |
| Example 40 | Ir66-Re34 | Ir90-Bi10 | good |
| Example 41 | Ir85-Re15 | Ir60-Bi10-Te30 | good |
| Example 42 | Ir66-Re34 | Ir50-Ru10-Te40 | good |
| Example 43 | Ir66-Re34 | Ir60-Pt30-Te10 | good |
| Example 44 | Ir85-Re15 | Ir30-Rh10-Te60 | good |

TABLE 3

| | | Contents of Te and | |
|---|---|---|---|
| | | Bi in glass | |
| | | material used in | Results of |
| | Film composition | pre-molding | molding |
| No. | of second layer | (atom %) | test |
| Example 45 | Ir66-Re34 | Te, 0.2; Bi, 0.0 | good |
| Example 46 | Ir66-Re34 | Te, 20; Bi, 0.0 | good |
| Example 47 | Ir66-Re34 | Te, 45; Bi, 0.0 | good |
| Example 48 | Ir66-Re34 | Te, 0.0; Bi, 5.0 | good |
| Example 49 | Ir66-Re34 | Te, 0.0; Bi, 15 | good |
| Example 50 | Ir66-Re34 | Te, 10; Bi, 5.0 | good |

While the present invention has been described in detail and with reference to specific embodiments thereof, it will be apparent to one skilled in the art that various changes and modifications can be made therein without departing from the spirit and scope thereof.

This application is based on Japanese Patent Application No. 2006-061193 filed on Mar. 7, 2006, and the contents thereof are incorporated herein by reference.

### INDUSTRIAL APPLICABILITY

According to the invention, a mold for optical glasses can be provided which is excellent in durability and releasability from optical glasses and is suitable for precision press molding. Furthermore, a process for producing an optical element can be provided in which an optical glass is press-molded with the mold of the invention to thereby produce any of various optical elements without necessitating polishing or the like after the molding. This process hence has excellent suitability for mass production and is advantageous in cost.

1. A mold for molding optical glass, the mold comprising:
a mold base; and
a protective film comprising one or two or more layers formed on the mold base,
the outermost layer of the protective film containing one or more elements selected from the group consisting of Al, Ga, In, TI, Ge, Sn, Pb, As, Sb, Bi, S, Se, and Te.

2. The mold for optical glass according to claim 1,
wherein the protective film comprises two or more layers, and a layer adjoining the outermost layer comprises noble-metal element.

3. The mold for optical glass according to claim 1,
wherein the outermost layer comprises noble-metal element.

4. The mold for optical glass according to claim 3,
wherein the outermost layer comprises:
1-70 atom % of one or more elements selected from the group consisting of Al, Ga, In, Ti, Ge, Sn, Pb, As, Sb, Bi, S, Se, and Te; and
30-99 atom % of noble-metal element.

5. The mold for optical glass according to claim 2,
wherein the noble-metal element containing one or more metallic elements selected from the group consisting of Ir, Re, Os, Pd, Pt, Au, Rh, Ru, Ta, and W.

6. The mold for optical glass according to claim 1,
wherein the mold base comprises a superhard alloy material or a silicon carbide material.

7. A process for producing a mold for molding optical glass,
the mold comprising:
a mold base; and
a protective film comprising one or two or more layers formed on the mold base,
the process comprising:
preliminarily molding a glass containing one or more elements selected from the group consisting of Al, Ga, In, Tl, Ge, Sn, Pb, As, Sb, Bi, S, Se, and Te to form a layer containing one or more elements selected from the group consisting of Al, Ga, In, Tl, Ge, Sn, Pb, As, Sb, Bi, S, Se, and Te as the outermost layer of the protective film.

8. A method for press-molding an optical glass with a pressing mold comprising an upper die and a lower die,
at least either of the upper die and the lower die being the mold for optical glass according to claim 1.
